(19) United States
(12) Patent Application Publication
(10) Pub. No.: US 2026/0235089 A1
(43) Pub. Date: Aug. 13, 2026

(54) SYSTEM AND METHOD FOR MANAGING TEMPERATURE IN AN ENGINE OF A VEHICLE

(71) Applicant: BRP-ROTAX GMBH & CO.KG, Gunskirchen (AT)

(72) Inventors: Bruno SCHUEHMACHER, Richmond (CA); Michael SEYRL, Wels (AT); Roland ENNSMANN, Gunskirchen (AT); Roland WIMMER, Eberstalzell (AT); Juergen RECHBERGER, Marchtrenk (AT)

(21) Appl. No.: 19/151,315

(22) PCT Filed: Jan. 26, 2024
(86) PCT No.: PCT/EP2024/051986

§ 371 Date: Jul. 26, 2025

Related U.S. Application Data
(60) Provisional application No. 63/481,820, filed on Jan. 27, 2023.

(51) Int. Cl. F02D 41/40; F02D 41/00; F02P 5/15

(52) U.S. Cl. CPC F02D 41/401; F02D 41/0007; F02P 5/1502; F02D 2200/101

(57) ABSTRACT

A method for managing temperature of a piston of an engine of a vehicle, the method being executed by a controller of the vehicle. The method includes determining at least one of a piston temperature of the piston and an engine speed (RPM) of the engine; and in response to the at least one of the piston temperature being above a piston temperature threshold, and the engine speed being above an engine speed threshold, modifying, by the controller, at least one engine operation value of the engine, the at least one engine operation value being modified such that increasing of the piston temperature is limited and/or causing coolant fluid to flow from a coolant container to an air intake flow path fluidly connected to the piston.

### CROSS-REFERENCE

The present application claims priority to U.S. Provisional Patent Application No. 63/481,820, entitled “System and Method for Managing Temperature in an Engine of a Vehicle,” filed Jan. 27, 2023, the entirety of which is incorporated by reference herein.

### FIELD OF TECHNOLOGY

The present technology relates to managing temperature in an engine.

### BACKGROUND

For internal combustion engines, such as those used in snowmobiles, the efficiency of the combustion process can be increased by compressing the air entering the engine. This can be accomplished using a turbocharger connected to the air intake and exhaust systems of the snowmobiles. The compression of the air by the turbocharger may be of particular importance when the internal combustion engine is operated in environments where atmospheric pressure is low.

While use of a turbocharger to increase air pressure can aid in improving engines efficiency, the process of compression can also cause the air to heat. Heating of air in a turbocharger can come from both pressure-related temperature rise due to the pressure-temperature relationship, as well as conduction of heat from exhaust gas turning the turbine through the turbocharger to the compressor. When compressed air from the turbocharger is too hot, the efficiency and performance of the engine can suffer due to engine detonation. Also referred to as “knocking”, engine detonation decreases engine efficiency by consuming a portion of the air-gas mixture at the wrong part of the stroke cycle of the engine. Heating and knocking can also be an issue in naturally aspirated engines (i.e. engines not provided with a turbocharger) when running at high engine load or speed. In both types of engines, overheating can further cause damage to pistons or other engine components.

In response to engine detonation, compression by the turbocharger is generally decreased or completely shut off or engine speed or load is decreased for naturally aspirated engines. This may reduce or eliminate detonation, but any benefit from the turbocharger is then lost. Similarly, the engine load can be decreased to address detonation, but there is similarly a loss in engine efficiency or power.

One solution that has been proposed to address this issue is the inclusion of an intercooler for cooling the compressed air prior to entering the engine. The intercooler can be space consuming, however, and must be both located near the engine and arranged to be cooled by oncoming air or snow projection (for snowmobiles). This can take up valuable space and complicates design in a compact engine arrangement.

There is thus a need for systems and methods for overcoming at least some of the above disadvantages.

### SUMMARY

It is an object of the present technology to ameliorate at least some of the inconveniences present in the prior art.

According to one aspect of the present technology, there is provided a vehicle including an air intake system which has a turbocharger and a coolant container fluidly connected to the intake air flow path, along which air flows prior to entering the engine. By providing cooling liquid, also referred to herein as coolant, coolant liquid, or coolant fluid, from the coolant container to the intake air flow path, at least some heating of intake air can be reduced. When the coolant is added to the air flow upstream of the compressor, some heat produced by compression in the compressor will be absorbed by the cooling liquid in the compressor by evaporation and heating of the cooling liquid. In some cases, the coolant could be added downstream of the compressor, such that air previously heated by the compressor will cause some cooling liquid to warm and/or evaporate thereby reducing the air prior to intake in the engine. In some cases, cooling liquid is selectively used to manage piston temperature of the engine.

While continuously providing cooling liquid to the air flow would ensure air cooling when the intake air becomes too hot, the coolant tanks necessary to provide enough cooling liquid for normal utilization of the vehicle would require a large volume and add a non-trivial weight to the vehicle. By the present technology, cooling liquid is thus selectively delivered to the intake air flow path when engine power or efficiency could be affected. Specifically, when an estimated or real piston temperature is above a threshold, i.e. when the intake air and/or the pistons 226 are heated to a temperature that causes a risk of detonation or could affect durability of the pistons. A controller for the system determines if the piston temperature and/or engine speed is above a predetermined threshold. When the piston temperature and/or engine speed pass the predetermined threshold, the controller selectively causes the coolant to flow to the air intake flow path. In at least some embodiments, the controller can cause coolant flow to improve fuel efficiency by permitting the engine to run at a higher speed while maintaining piston temperature in a good operational range by cooling from the coolant fluid. In some such cases, a smaller fuel tank may then be supplied. Such methods could also be applied to naturally aspirated engines.

The present technology also provides methods for managing piston temperature by the controller using engine operation values, or parameters, which affect piston temperature changes. Specifically, when an estimated or real piston temperature is above a threshold, i.e. when the intake air and/or the pistons 226 are heated to a temperature that causes a risk of detonation or could affect durability of the pistons, operation of the engine changes to limit temperature increases. The controller for the system determines if the piston temperature and/or engine speed is above a predetermined threshold. When the piston temperature and/or engine speed pass the predetermined threshold, the controller selectively modifies or adjusts one or more engine operation values according to their effect on piston temperature changes. When used in conjunction with coolant application, the method can control piston temperature up to a certain threshold, above which engine operation is additionally modified to control piston temperature.

According to one aspect of the present technology, there is provided a method for managing temperature of a piston of an engine of a vehicle, the method being executed by a controller of the vehicle. The method including determining at least one of: a piston temperature of the piston, an engine load of the engine, and an engine speed (RPM) of the engine; and in response to the at least one of: the piston temperature being above a piston temperature threshold, the engine load being above an engine load threshold, and and the engine speed being above an engine speed threshold, modifying, by the controller, at least one engine operation value of the engine, the at least one engine operation value being modified such that increasing of the piston temperature is limited.

In some embodiments, the at least one engine operation value is at least one of an ignition timing of the engine; an air-to-fuel ratio; an exhaust valve position; a fuel injection timing; a fuel injection quantity; and a boost pressure from a turbocharger of the vehicle.

In some embodiments, the piston temperature threshold is a first piston temperature threshold; modifying the at least one engine operation value comprises modifying the at least one engine operation value in response to the piston temperature being above the first piston temperature threshold; and further including in response to the piston temperature being above a second piston temperature threshold, causing coolant fluid to flow from a coolant container to an air intake flow path fluidly connected to the piston.

In some embodiments, an amount of coolant flowing to the air intake flow path is based at least in part on at least one of the piston temperature and the engine speed.

In some embodiments, the first piston temperature threshold is greater than the second piston temperature threshold.

In some embodiments, the method further includes determining that a fluid level of coolant fluid in the coolant container is below a minimum fluid level; and in response to determining that the fluid level is below the minimum fluid level, causing fluid to stop flowing from the coolant container to the air intake flow path.

In some embodiments, the method further includes determining that the coolant container is empty; and subsequent to determining that the coolant container is empty, in response to the piston temperature being above a third piston temperature threshold, modifying the at least one engine operation value, the third piston temperature threshold being less than the first piston temperature threshold.

In some embodiments, the method further includes causing an amount of coolant fluid to flow from a coolant container to an air intake flow path fluidly connected to the piston, in response to the engine speed being above the engine speed threshold.

In some embodiments, causing coolant fluid to flow includes determining an amount of coolant fluid to cause to flow based at least in part on at least one of the piston temperature; ambient temperature; primary plenum temperature; time spent above a predetermined engine load; and time spent above a predetermined engine speed.

In some embodiments, determining the amount of coolant fluid to cause to flow is further based at least in part on at least one of the engine speed; and the engine load.

In some embodiments, determining the at least one of the piston temperature and the engine speed includes determining the piston temperature, and determining at least one of the engine speed and the engine load.

In some embodiments, determining the piston temperature comprises determining an estimated piston temperature based on a plurality of engine operational parameters.

According to another aspect of the present technology, there is provided a method for managing temperature of a piston of an engine of a vehicle, the method being executed by a controller of the vehicle. The method includes determining at least one of a piston temperature of the piston; an engine load of the engine, and an engine speed of the engine; and in response to the at least one of the piston temperature being above a piston temperature threshold, the engine load being above an engine load threshold, and the engine speed being above an engine speed threshold, causing an amount of coolant fluid to flow from a coolant container to an air intake flow path fluidly connected to the piston.

In some embodiments, causing the amount of coolant fluid to flow comprises determining the amount of coolant fluid based at least in part on at least one of the piston temperature; an ambient temperature; a primary plenum temperature; a time spent above a predetermined engine load; and a time spent above a predetermined engine speed.

In some embodiments, determining the amount of coolant fluid further comprises determining at least one of the engine speed; and an engine load, the amount being further based at least in part on the at least one of the engine speed and the engine load.

In some embodiments, the at least one of the piston temperature and the engine speed includes determining the piston temperature and determining the engine speed.

In some embodiments, determining the piston temperature comprises determining an estimated piston temperature based on a plurality of engine operational parameters.

In some embodiments, determining the estimated piston temperature includes determining, by a throttle position sensor connected to the controller, a throttle position of a throttle valve of the engine; and determining, by an engine speed sensor connected to the controller, the engine speed.

In some embodiments, the method further includes determining that a fluid level of coolant fluid in the coolant container is below a minimum fluid level; and in response to determining that the fluid level is below the minimum fluid level, causing fluid to stop flowing from the coolant container to the air intake flow path.

In some embodiments, the method further includes determining that the coolant container is empty; and subsequent to determining that the coolant container is empty, in response to the piston temperature being above a second piston temperature threshold, modifying at least one engine operation value, the at least one engine operation value being modified such that increasing of the piston temperature is limited.

According to yet another aspect of the present technology, there is provided a vehicle including a frame; an engine supported by the frame, the engine having at least one engine air inlet; a turbocharger fluidly connected to the engine, the turbocharger including a compressor fluidly connected to the at least one engine air inlet, the compressor having a compressor inlet and a compressor outlet, an intake air flow path of the vehicle being defined from air entering the vehicle, passing through the compressor inlet into the compressor, passing out of the compressor through the compressor outlet, and flowing into the at least one engine air inlet; a coolant container assembly supported by the frame, the coolant container assembly comprising a coolant container for holding cooling liquid, the coolant container assembly being fluidly connected to the intake air flow path at at least one connection point; a coolant sensor operatively connected to the coolant container; and a controller communicatively connected with the coolant container assembly and the coolant sensor, the controller being configured to selectively cause of an amount of cooling liquid to flow from the coolant container into the intake air flow path via the connection point.

In some embodiments, the controller is communicatively connected to the engine; and the controller is configured to: determine an estimated piston temperature based on at least one engine operation value received from the engine, and selectively cause of an amount of cooling liquid to flow from the coolant container into the intake air flow path via the at least one connection point based on at least the estimated piston temperature.

In some embodiments, the coolant sensor includes at least one of a coolant level sensor and a coolant pressure sensor.

In some embodiments, the coolant sensor includes the coolant level sensor; the controller is further configured to: determine, via the coolant level sensor, that a fluid level of coolant fluid in the coolant container is below a minimum fluid level; and in response to determining that the fluid level is below the minimum fluid level, cause coolant fluid to stop flowing from the coolant container to the air intake flow path.

In some embodiments, the coolant level sensor is configured to determine that the coolant container is empty.

In some embodiments, the engine includes at least one reed valve and at least one throttle valve; and the at least one connection point is disposed on the intake air flow path between the at least one reed valve and the at least one throttle valve.

In some embodiments, the vehicle further includes at least one coolant-injection collar fluidly connected to the at least one engine air inlet; at least one injection nozzle connected to and extending through the at least one coolant-injection collar, the at least one injection nozzle being fluidly connected to the coolant container assembly; and the at least one connection point is defined by the at least one nozzle.

In some embodiments, the at least one engine air inlet includes a first inlet providing air to a first cylinder of the engine, and a second inlet providing air to a second cylinder of the engine; the at least one coolant-injection collar includes: a first coolant-injection collar connected to the engine and aligned with the first inlet, and a second coolant-injection collar connected to the engine and aligned with the second inlet; and the at least one injection nozzle includes a first nozzle connected to and extending through the first coolant-injection collar, the first nozzle being fluidly connected to the coolant container assembly; and a second nozzle connected to and extending through the second coolant-injection collar, the second nozzle being fluidly connected to the coolant container assembly.

According to yet another aspect of the present technology, there is provided a vehicle including a frame; an engine supported by the frame, the engine having at least one engine air inlet, an intake air flow path of the vehicle being defined from air entering the vehicle and flowing into the at least one engine air inlet; a coolant container assembly supported by the frame, the coolant container assembly comprising a coolant container for holding cooling liquid, the coolant container assembly being fluidly connected to the intake air flow path at at least one connection point; a coolant sensor operatively connected to the coolant container; and a controller communicatively connected with the coolant container assembly and the coolant sensor, the controller being configured to selectively cause of an amount of cooling liquid to flow from the coolant container into the intake air flow path via the connection point.

In some embodiments, the controller is communicatively connected to the engine; and the controller is configured to: determine an estimated piston temperature based on at least one engine operation value received from the engine, and selectively cause an amount of cooling liquid to flow from the coolant container into the intake air flow path via the at least one connection point based on at least the estimated piston temperature.

In some embodiments, the coolant sensor includes the coolant level sensor; the controller is further configured to: determine, via the coolant level sensor, that a fluid level of coolant fluid in the coolant container is below a minimum fluid level; and in response to determining that the fluid level is below the minimum fluid level, cause coolant fluid to stop flowing from the coolant container to the air intake flow path.

In some embodiments, the coolant level sensor is configured to determine that the coolant container is empty.

For purposes of this application, the term “fluid” is meant to include at least both gases and liquids, as well as a combination of gases and liquids.

For purposes of this application, terms related to spatial orientation such as forwardly, rearward, upwardly, downwardly, left, and right, are as they would normally be understood by a driver of the snowmobile sitting thereon in a normal riding position. Terms related to spatial orientation when describing or referring to components or sub-assemblies of the snowmobile, separately from the snowmobile, such as a heat exchanger for example, should be understood as they would be understood when these components or sub-assemblies are mounted to the snowmobile, unless specified otherwise in this application.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein. The explanations provided above regarding the above terms take precedence over explanations of these terms that may be found in any one of the documents incorporated herein by reference.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a left side elevation view of a snowmobile;

FIG. 2 is a top, rear, right side perspective view of an engine, air intake system and exhaust system of the snowmobile of FIG. 1;

FIG. 3 is a front elevation view of the engine, air intake system and exhaust system of FIG. 2;

FIG. 4 is a cross-sectional view of the engine and some portions of the air intake system and the exhaust system of FIG. 2;

FIG. 5 is a top plan view of portions of the air intake system and the exhaust system of FIG. 2;

FIG. 6 is a schematic representation of the exhaust system of FIG. 2;

FIG. 7 is a right side elevation view of portions of the air intake system and the exhaust system of FIG. 2;

FIG. 8 is a top plan view of portions of the engine, the air intake system, a fuel tank, and a coolant system of the vehicle of FIG. 1;

FIG. 9 is a left side elevation view of the vehicle portions of FIG. 8;

FIG. 10 is a right side elevation view of the vehicle portions of FIG. 8;

FIG. 11 is a top plan view of portions of the air intake system and the coolant system of FIG. 8;

FIG. 12 is a top, front, left side perspective view of the air intake system and coolant system portions of FIG. 11;

FIG. 13 is an exploded, top front, left side perspective view of the air intake system and coolant system portions of FIG. 11;

FIG. 14 is a flowchart illustrating a method according to the present technology for operating the air intake system and coolant system of FIG. 8;

FIG. 15 is a schematic view of the engine, the air intake system of FIG. 11, and another embodiment of a coolant system;

FIG. 16 is a perspective view of portions of the engine of the vehicle of FIG. 1, with coolant-injection collars attached thereto;

FIG. 17 is a cross-sectional view of the engine and the coolant-injection collars of FIG. 16, taken along line 17-17 of FIG. 17;

FIG. 18 is a perspective view of the coolant-injection collars of FIG. 16, with coolant tubes connected thereto;

FIG. 19 is a perspective, exploded view of coolant injection nozzles of the coolant-injection collars of FIG. 16;

FIG. 20 is a flowchart illustrating a method according to the present technology for managing piston temperature of the engine of the vehicle of FIG. 1;

FIG. 21 illustrates an example dataset used in the method of FIG. 20;

FIG. 22 is a flowchart illustrating a method according to the present technology for managing piston temperature of the engine of the vehicle of FIG. 1; and

FIG. 23 is a flowchart illustrating a method according to the present technology for managing piston temperature of the engine of the vehicle of FIG. 1.

It should be noted that the Figures may not be drawn to scale, except where otherwise noted.

### DETAILED DESCRIPTION

The present technology is described herein with respect to a snowmobile 10 having an internal combustion engine and two skis. However, it is contemplated that some aspects of the present technology may apply to other types of vehicles such as, but not limited to, snowmobiles with a single ski, road vehicles having two, three, or four wheels, off-road vehicles, all-terrain vehicles, side-by-side vehicles, and personal watercraft.

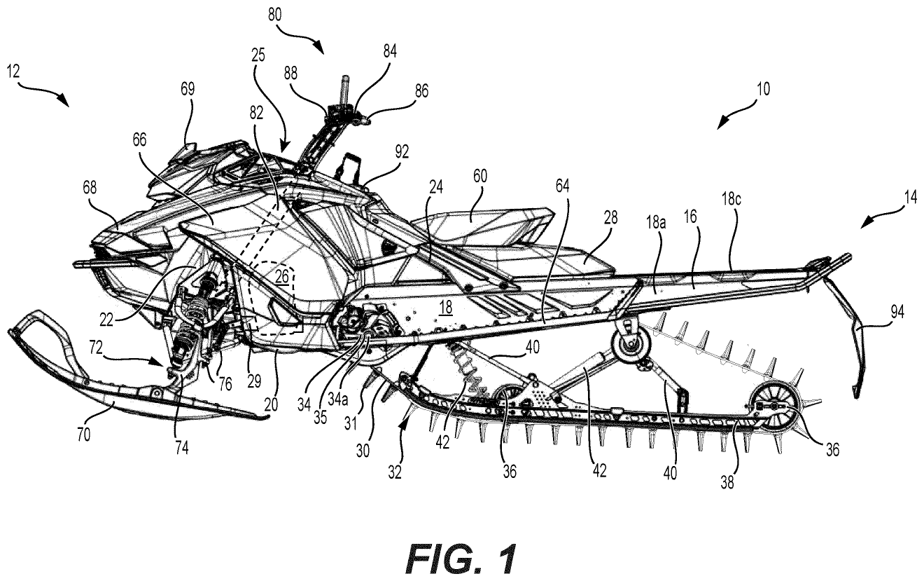

With reference to FIG. 1, a snowmobile 10 according to the present technology will be described. The snowmobile 10 includes a forward end 12 and a rearward end 14. The snowmobile 10 includes a vehicle body in the form of a frame or chassis 16 which includes a tunnel 18, an engine cradle portion 20, a front suspension module 22 and an upper structure 24.

An internal combustion engine 26 is carried in an engine compartment defined in part by the engine cradle portion 20 of the frame 16. A fuel tank 28, supported above the tunnel 18, supplies fuel to the engine 26 for its operation. The engine 26 receives air from an air intake system 100. The engine 26 and the air intake system 100 are described in more detail below.

An endless drive track 30 is positioned at the rear end 14 of the snowmobile 10. The drive track 30 is disposed generally under the tunnel 18 and is operatively connected to the engine 26 through a belt transmission system and a reduction drive. The endless drive track 30 is driven to run about a rear suspension assembly 32 operatively connected to the tunnel 18 for propulsion of the snowmobile 10. The endless drive track 30 has a plurality of lugs 31 extending from an outer surface thereof to provide traction to the track 30.

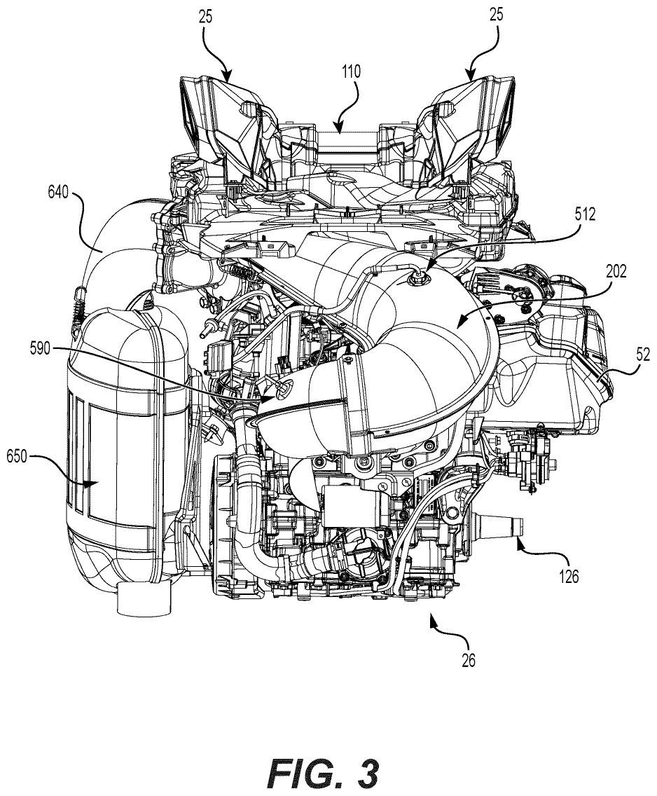

The rear suspension assembly 32 includes drive sprockets 34, idler wheels 36 and a pair of slide rails 38 in sliding contact with the endless drive track 30. The drive sprockets 34 are mounted on an axle 35 and define a sprocket axis 34a. The axle 35 is operatively connected to a crankshaft 126 (see FIG. 3) of the engine 26. The slide rails 38 are attached to the tunnel 18 by front and rear suspension arms 40 and shock absorbers 42. It is contemplated that the snowmobile 10 could be provided with a different implementation of a rear suspension assembly 32 than the one shown herein.

A straddle seat 60 is positioned atop the fuel tank 28. A fuel tank filler opening covered by a cap 92 is disposed on the upper surface of the fuel tank 28 in front of the seat 60. It is contemplated that the fuel tank filler opening could be disposed elsewhere on the fuel tank 28. The seat 60 is adapted to accommodate a driver of the snowmobile 10. The seat 60 could also be configured to accommodate a passenger. A footrest 64 is positioned on each side of the snowmobile 10 below the seat 60 to accommodate the driver's feet.

At the front end 12 of the snowmobile 10, fairings 66 enclose the engine 26 and the belt transmission system, thereby providing an external shell that not only protects the engine 26 and the transmission system but can also make the snowmobile 10 more aesthetically pleasing. The fairings 66 include a hood 68 and one or more side panels which can be opened to allow access to the engine 26. A windshield 69 connected to the fairings 66 acts as a wind screen to lessen the force of the air on the rider while the snowmobile 10 is moving.

Two skis 70 positioned at the forward end 12 of the snowmobile 10 are attached to the front suspension module 22 of the frame 16 through a front suspension assembly 72. The front suspension module 22 is connected to the front end of the engine cradle portion 20. The front suspension assembly 72 includes ski legs 74, supporting arms 76 and ball joints (not shown) for operatively connecting to the respective ski leg 74, supporting arms 76 and a steering column 82 (schematically illustrated).

A steering assembly 80, including the steering column 82 and a handlebar 84, is provided generally forward of the seat 60. The steering column 82 is rotatably connected to the frame 16. The lower end of the steering column 82 is connected to the ski legs 74 via steering rods (not shown). The handlebar 84 is attached to the upper end of the steering column 82. The handlebar 84 is positioned in front of the seat 60. The handlebar 84 is used to rotate the steering column 82, and thereby the skis 70, in order to steer the snowmobile 10. A throttle operator 86 in the form of a thumb-actuated throttle lever is mounted to the right side of the handlebar 84. Other types of throttle operators, such as a finger-actuated throttle lever and a twist grip, are also contemplated. A brake actuator 88, in the form of a hand brake lever, is provided on the left side of the handlebar 84 for braking the snowmobile 10 in a known manner. It is contemplated that the windshield 69 could be connected directly to the handlebar 84.

At the rear end of the snowmobile 10, a snow flap 94 extends downward from the rear end of the tunnel 18. The snow flap 94 protects against dirt and snow that can be projected upward from the drive track 30 when the snowmobile 10 is being propelled by the moving drive track 30. It is contemplated that the snow flap 94 could be omitted.

The snowmobile 10 includes other components such as a display cluster, and the like. As it is believed that these components would be readily recognized by one of ordinary skill in the art, further explanation and description of these components will not be provided herein.

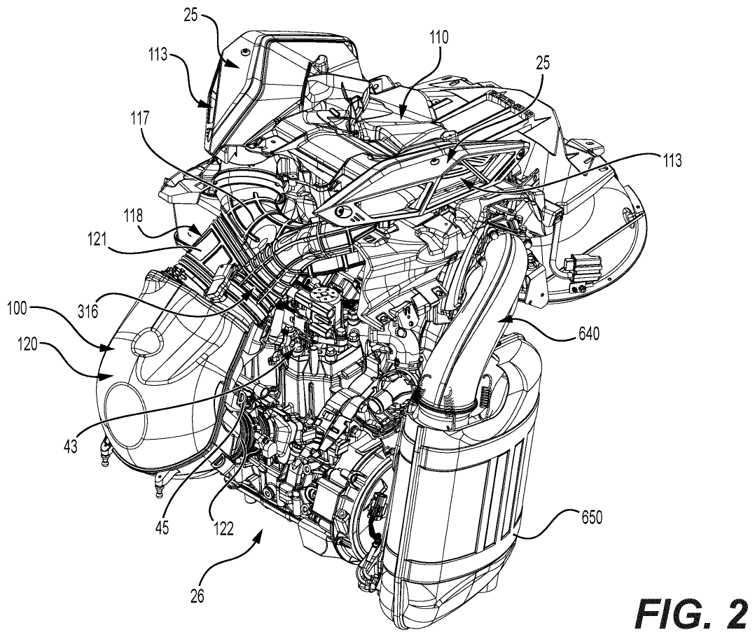

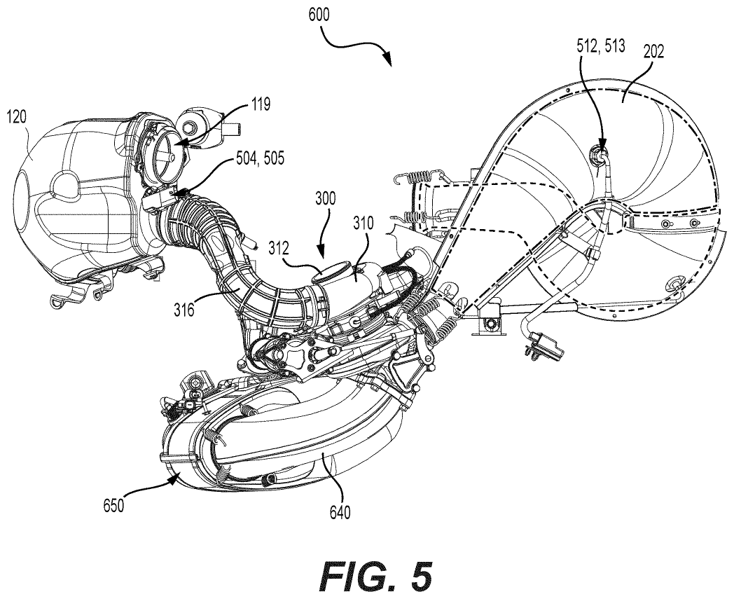

With additional reference to FIGS. 2 to 5, the engine 26 and the air intake system 100 will be described in more detail. Air from the atmosphere surrounding the snowmobile 10 flows through side apertures 113 defined in an upper portion 25 of the upper structure 24 of the chassis 16. The air then flows into a secondary airbox 110. The secondary airbox 110 is disposed above the front suspension module 22. A generally Y-shaped conduit 118 (FIG. 2) fluidly connects the secondary airbox 110, via a conduit portion 117, to a compressor inlet 312 of an air compressor 310 (FIG. 5) of a turbocharger 300 disposed on the right side of and operatively connected to the engine 26. The conduit 118 further fluidly connects to an inlet 119 of a primary airbox 120 via a conduit portion 121. It is contemplated that the secondary airbox 110 could be omitted and that air from the atmosphere could directly enter into the inlet 312 and/or the inlet 119 of the primary airbox 120 without going through the secondary airbox 110.

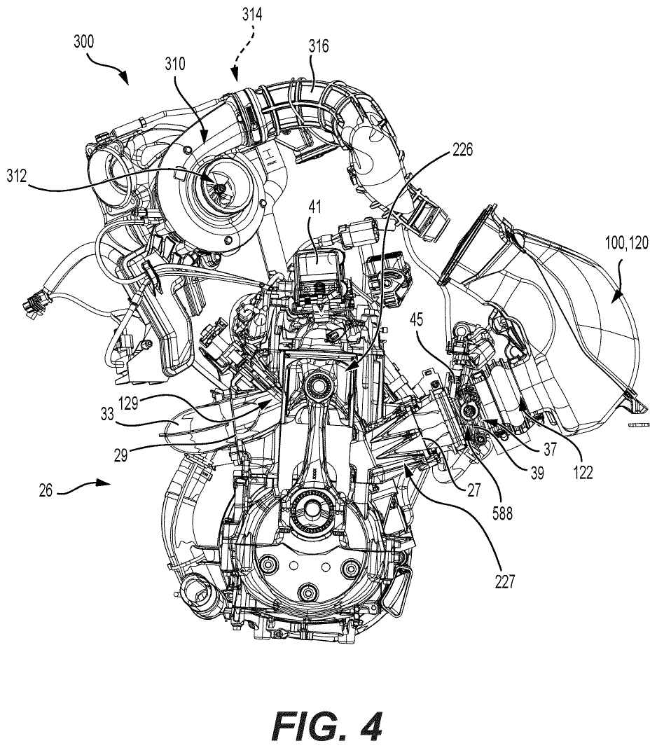

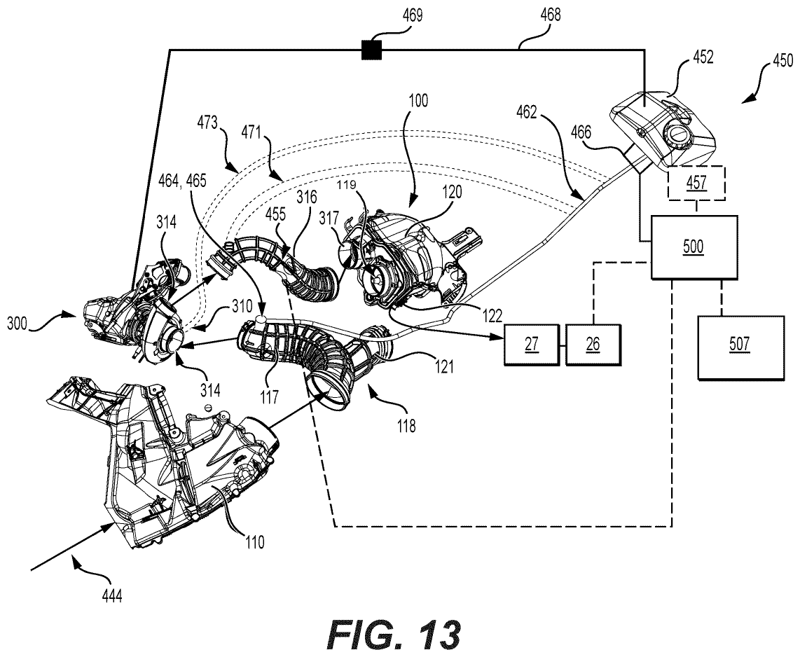

Air from the environment entering the snowmobile 10, passing through the air compressor 310, and flowing into the engine 26 generally follows an intake air flow path 444, illustrated schematically in FIG. 13. Air from the atmosphere, passing through the secondary airbox 110 and into the air compressor 310 via the conduit 118 and inlet 312, is compressed by the air compressor 310. The compressed air then flows out of the air compressor 310 through an outlet 314, into a conduit 316 and into the primary air box 120. The primary airbox 120 is fluidly connected to the engine 26 via two air outlets 122 of the primary airbox 120 (see FIG. 4).

The engine 26 is an inline, two-cylinder, two-stroke, internal combustion engine. The two cylinders of the engine 26, with a piston 226 disposed in each cylinder, are oriented with their cylindrical axes disposed vertically, one piston 226 is illustrated in FIG. 4. It is contemplated that the engine 26 could be configured differently. For example, the engine 26 could have more or less than two cylinders, and the cylinders could be arranged in a V-configuration instead of in-line. It is contemplated that in some implementations the engine 26 could be a four-stroke internal combustion engine, a carbureted engine, or any other suitable engine capable of propelling the snowmobile 10. While the present embodiment of snowmobile 10 utilized the turbo 100 for supplying compressed air to the engine 26, it is also contemplated that at least some aspects of the present technology could be applied to and implemented in snowmobiles with naturally aspirated engines (i.e. without a turbocharger).

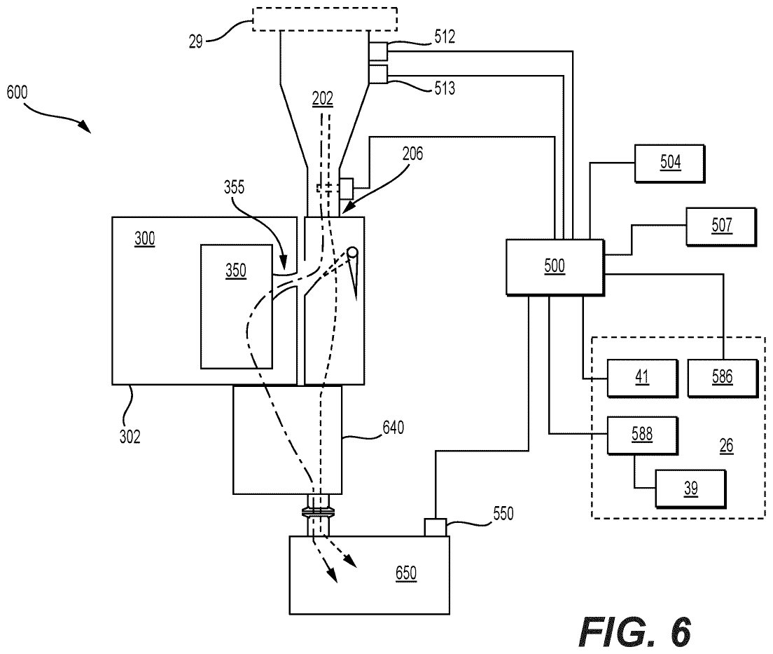

As shown in FIGS. 1, 2, and 4, the engine 26 receives air from the air intake system 100, specifically the outlets 122 of the primary airbox 120, via engine air inlets 27 defined in the rear portion of each cylinder of the engine 26. The engine 26 includes reed valves 227 in each air inlet 27. Each air inlet 27 is connected to a throttle body 37 of the air intake system 100. The throttle body 37 includes a throttle valve 39 which rotates to regulate the amount of air flowing through the throttle body 37 into the corresponding cylinder of the engine 26. A throttle valve actuator (not shown) is operatively connected to the throttle valve 39 to change the position of the throttle valve 39 and thereby adjust the opening of the throttle valve 39 with operation of the throttle lever 86 on the handlebar 84. In the present implementation, the throttle valve actuator is a mechanical linkage, although this is simply one non-limiting implementation. The position and the movement of the throttle valve 39 is monitored by a throttle position sensor 588 (schematically illustrated in FIG. 6) operatively connected to the throttle valve 39, described in more detail below. It is also contemplated that the throttle valve actuator could be in the form of an electric motor. The electric motor could change the position of the throttle valve 39 based on input signals received from an electronic control module (not shown) which in turn receives inputs signals from a position sensor associated with the throttle lever 86 on the handlebars 84. Further details regarding such drive-by wire throttle systems can be found in U.S. Pat. No. 10,029,567 issued on Jul. 24, 2018, the entirety of which is incorporated herein by reference.

The engine 26 receives fuel from the fuel tank 28 via Direct Injection (DI) injectors 41 and Multi Point Fuel Injection (MPFI) injectors 45 (both shown in FIG. 4), having an opening in the cylinders. The fuel-air mixture in each of the left and right cylinders of the engine 26 is ignited by an ignition system including spark plugs 43 (best seen in FIG. 2). Engine output power, torque and engine speed are determined in part by throttle opening and in part by the ignition timing, and also by various characteristics of the fuel-air mixture such as its composition, temperature, pressure and the like.

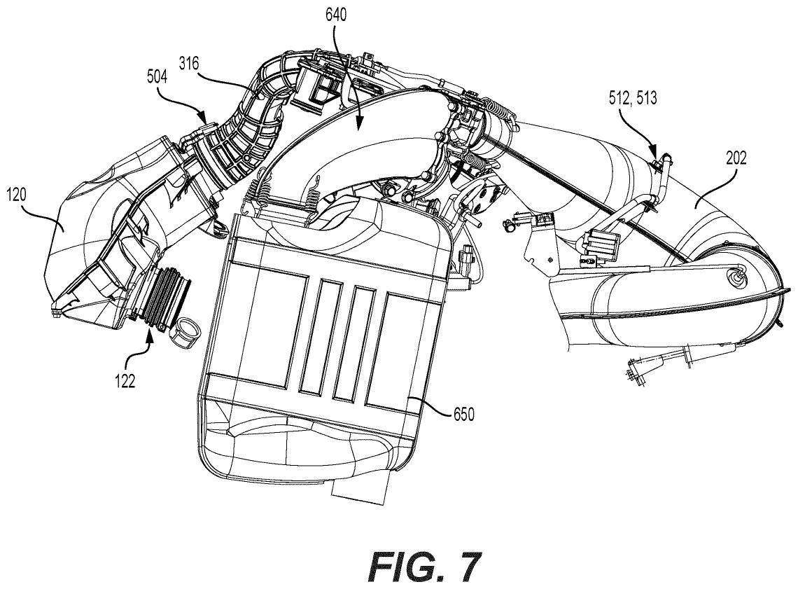

Exhaust gases resulting from the combustion events of the combustion process are expelled from the engine 26 via an exhaust system 600, illustrated in FIGS. 5 to 7. As shown in FIG. 4, an exhaust outlet 29 is defined in the front portion of each cylinder of the engine 26. Each exhaust outlet 29 has an exhaust valve 129. The exhaust outlets 29 are fluidly connected to an exhaust manifold 33. The exhaust system 600 includes an exhaust pipe 202 which is connected to the exhaust manifold 33 and extends forwardly therefrom to direct the exhaust gases out of the engine 26. In the present implementation, the exhaust pipe 202 is a tuned pipe which has a geometry suitable for improving efficiency of the engine 26.

The exhaust gas expelled from the engine 26 flows through the exhaust outlets 29, through the exhaust manifold 33, and into the exhaust pipe 202, as is mentioned above. The exhaust pipe 202, which as mentioned above is a tuned pipe 202, is curved and has a varying diameter along its length. Other types of exhaust pipes 202 are contemplated. The exhaust system 600 further includes an exhaust collector 640 (FIG. 2) fluidly connected to the engine 26 via the exhaust pipe 202 and to the turbocharger 300. With reference to FIG. 2, the exhaust system 600 includes a muffler 650. The muffler 650 is fluidly connected to the exhaust collector 640. The exhaust collector 640 and the muffler 650 are held in place by springs as can be seen in the Figures. It is contemplated that different methods could be employed to connect the muffler 650 to the exhaust collector 640.

The snowmobile 10 further includes a system controller 500 for controlling and managing various operational aspects of the snowmobile 10. The system controller 500 is operatively connected to an engine control unit (or ECU) and/or the electrical system (not shown) of the snowmobile 10. The engine control unit is in turn operatively connected to the engine 26. As will be described in more detail below, the system controller 500 is also operatively and communicatively connected to an atmospheric pressure sensor 504 (shown schematically in FIG. 5). The atmospheric pressure sensor 504, also referred to as an air intake sensor 504 or intake pressure sensor 504, senses the atmospheric or ambient air pressure of the intake air coming into the air intake system 100. It should be noted that the atmospheric pressure sensor 504 senses the air pressure in the primary airbox 120, and as such measures the air intake pressure from air entering either from the ambient air around the snowmobile 10 and/or the air entering the primary airbox 120 from the turbocharger 300.

Also shown schematically in FIG. 5, the system controller 500 is also operatively and communicatively connected to an atmospheric temperature sensor 505, also referred to as an air intake temperature sensor 505, for sensing the atmospheric or ambient air temperature of the intake air coming into the air intake system 100. It should be noted that the atmospheric temperature sensor 505 senses the air temperature in the primary airbox 120, and as such measures the air intake temperature from air entering either from the ambient air around the snowmobile 10 and/or the air entering the primary airbox 120 from the turbocharger 300.

As is illustrated in the schematic diagram of FIG. 6 and as will be described in more detail below, the system controller 500 is also operatively connected to the throttle valve position sensor 588 for determining the position of the throttle valve 39, a rate of opening of the throttle valve 39, or both.

As is also illustrated in FIG. 6, the system controller 500 is further connected to several sensors for monitoring various exhaust system components. The system controller 500 is communicatively connected to an exhaust pipe temperature sensor 512 to detect the temperature of the exhaust pipe 202. As can be seen in FIG. 5, the exhaust pipe temperature sensor 512 includes a temperature probe connected to an outer wall of the exhaust pipe 202, but other positions along the exhaust pipe 202 are contemplated. The temperature probe extends within the exhaust pipe 202 so as to measure the temperature of the exhaust gas circulating therein. The system controller 500 is also communicatively connected to an exhaust oxygen sensor 513 to detect a concentration of oxygen in the exhaust transiting the exhaust pipe 202. The exhaust oxygen sensor 513 includes a probe connected to and extending through the outer wall of the exhaust pipe 202, but other positions along the exhaust pipe 202 are contemplated.

In order to determine an engine speed of the engine 26, the system controller 500 is further communicatively connected to an engine speed sensor 586 disposed in communication with the engine 26.

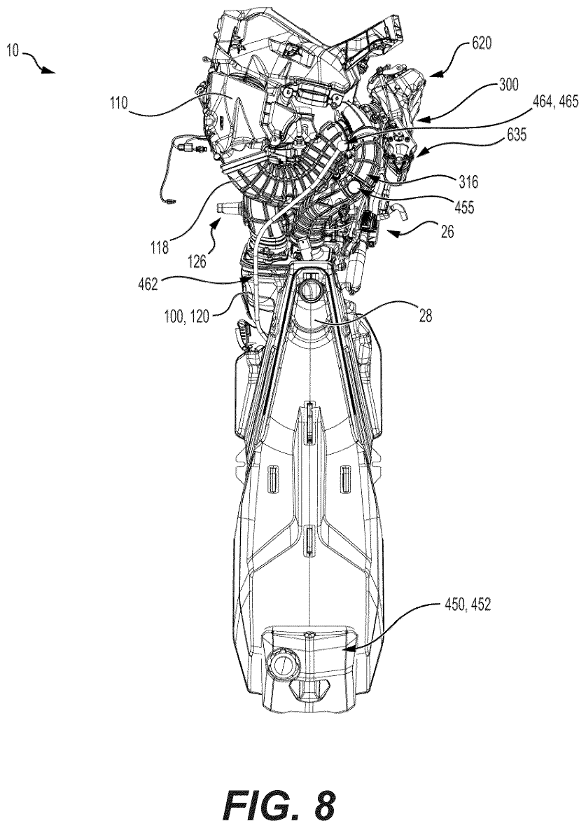

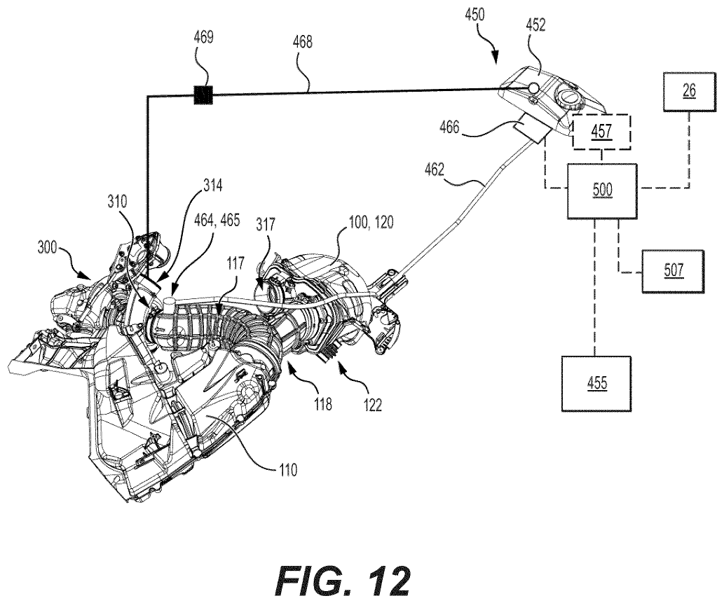

With reference to FIGS. 8 through 14, as well as FIG. 4, components and methods for managing engine air intake temperature for air entering the engine 26 of the snowmobile 10 will now be described.

Air which is compressed by the compressor 310 of the turbocharger 300 and supplied to the engine 26 generally follows the intake air flow path 444, which is described above and illustrated schematically in FIG. 13. Briefly, air from the atmosphere surrounding the snowmobile 10 flows through the side apertures 113 of the chassis 16 and into the secondary airbox 110. The conduit portion 117 of the Y-shaped conduit 118 fluidly connects at one end to the secondary airbox 110 and to the compressor inlet 312 of the compressor 310 at the other end. The air entering the inlet 312 is then compressed by the compressor 310. The compressed air then flows out of the compressor outlet 314 and into the conduit 316. Air thus flows through one end of the conduit 316 fluidly connected to the compressor outlet 314 and into to the primary air box 120 through the other end of the conduit 316. Air then flows from the primary airbox 120 into the engine 26 via the two air outlets 122 fluidly connected to the engine air inlets 27 (depicted in FIG. 4 and shown schematically in FIG. 13).

In the process of compressing the air in the compressor 310, the temperature of the air to be sent to the engine 26 can increase. In order to manage the temperature of intake air, the snowmobile 10 includes a coolant container assembly 450 for selectively holding and delivering cooling liquid to the intake air flow path 444. As will be described further below, the coolant container assembly 450 can also be used to manage piston temperature, including in embodiments where the turbocharger is omitted and the intake air temperature is not necessarily elevated.

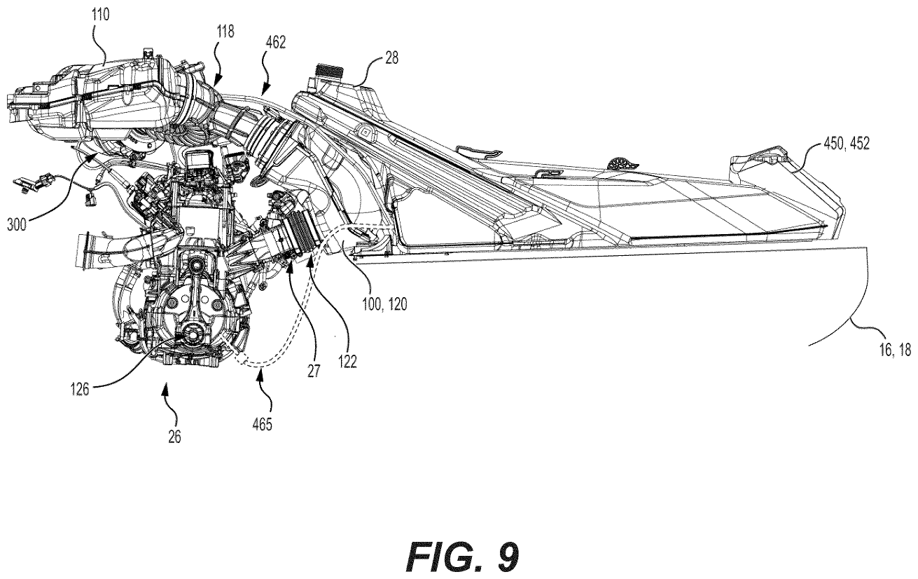

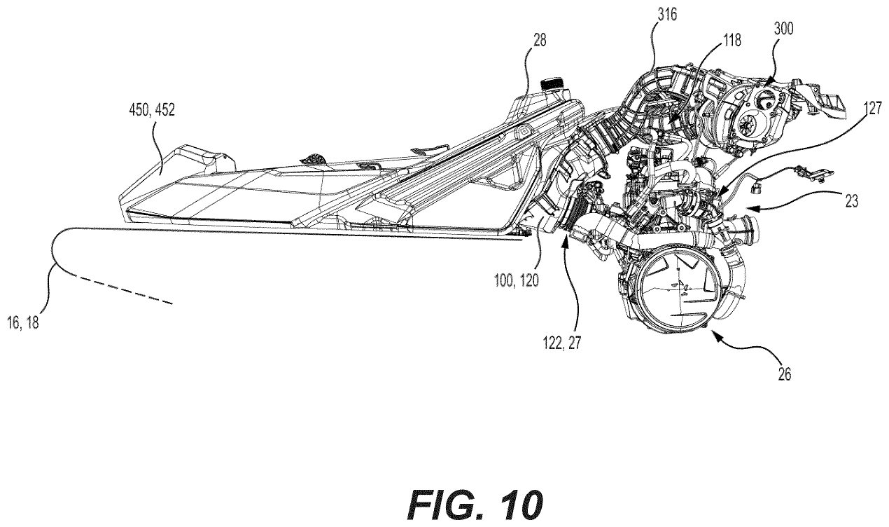

The coolant container assembly 450 includes a coolant container 452 supported by the frame 16, specifically by the tunnel 18 (shown schematically in FIGS. 9 and 10). The container 452 is disposed immediately rearward of the fuel tank 28 in a space formed by the fuel tank 28, although in some implementations the container 452 could be located elsewhere.

The coolant container 452, when in use, holds approximately 2 liters of a water-ethanol mix. Depending on the implementation, the coolant container 452 could have a larger or smaller volume. The size of the coolant container 452 for a given implementation is generally adapted for an intended use of the specific vehicle 10. For example, implementations of the snowmobile 10 meant to be utilized in mountainous conditions could be provided with a different size coolant container 452 than an implementation of the snowmobile 10 meant for use on standard trails. While continuously providing cooling liquid to the intake air flow path 444 from the coolant container 452 would also aid in managing the intake air temperature, this would require a large tank of cooling liquid. In the present technology, a smaller container 452 is instead provided to limit the volume and weight, and the cooling liquid is only selectively delivered to the intake air flow path 444 (described in more detail below).

The particular cooling liquid used could also depend on different implementations of the snowmobile 10, or from one set of operating conditions to another for any particular vehicle. Various cooling liquids could be used, including but not limited to: water, ethanol, isopropanol, ethylene glycol, methanol, and combinations thereof. The snowmobile 10 includes one or more coolant sensors for monitoring the coolant in the coolant container 452, the coolant sensor being a coolant level sensor and/or a coolant pressure sensor. In the illustrated implementation, the coolant container 452 also includes a coolant level sensor 457 for sensing a level of the cooling liquid in the coolant container 452. The coolant level sensor 457 is configured to determine that the coolant container 452 is empty or that the fluid level of coolant fluid in the container 452 is below a minim fluid level. In some cases, the coolant level sensor 457 could be connected to a cooling liquid gauge on display for the user. In some cases, an alert could be communicated to the user that the cooling liquid in the coolant container 452 has fallen below some threshold level. In some other embodiments, the snowmobile 10 could use a coolant pressure sensor to monitor the coolant levels. In such embodiments, the coolant pressure sensor could be connected downstream from the coolant container 452. When the coolant pressure is detected to be below a predetermined threshold, it could be determined that the coolant level has fallen below some threshold and/or that there is an issue with movement of the coolant out of the coolant container 452.

A coolant tube 462 is fluidly connected to the coolant container 452 for delivering the cooling liquid from the coolant container 452 to the intake air flow path 444. Specifically, coolant tube 462 fluidly connects between the coolant container 452 and the intake air flow path 444 at a connection point 464. In at least some embodiments, it is contemplated that the liquid level sensor 457 could be replaced, or supplemented by, a pressure sensor along the coolant tube 462 for sensing pressure of the cooling liquid passing therethrough.

In the illustrated implementation, the connection point 464 is on the conduit 117 for delivering cooling liquid to the intake air flow path 444 upstream of the compressor 310. At the connection point 464 on the conduit 117 there is an injection nozzle 465 fluidly connected to the coolant tube 462 and directed into the conduit 117 for delivering the cooling liquid therein. In the present implementation, the coolant tube 462 passes under the fuel tank 28. It is contemplated that the coolant tube 462 could be differently arranged within the snowmobile 10 depending on particular details of a given implementation.

Depending on the particular implementation, the connection point 464 and the injection nozzle 465 could be located elsewhere. In some implementations, the connection point 464 could be located on the conduit 316, as is illustrated schematically by an alternative path of a coolant tube 471 of FIG. 13. In other implementations, the connection point 464 could be located in the compressor inlet 312, illustrated schematically by an alternative coolant tube 473 of FIG. 13. In other implementations, the connection point 464 could be located in a crankcase of the engine 26, where intake air passes prior to entering combustion chambers of the engine 26. In such an implementation (illustrated schematically by an alternative coolant tube 465 of FIG. 9), it is also contemplated that some portion of the cooling liquid could also contact pistons 226 of the engine 26 when injected into the crankcase, further aiding in reducing the piston temperature. It is also contemplated that multiple connections points and/or multiple injection nozzles could be included. It is further contemplated that yet other arrangements could be implemented.

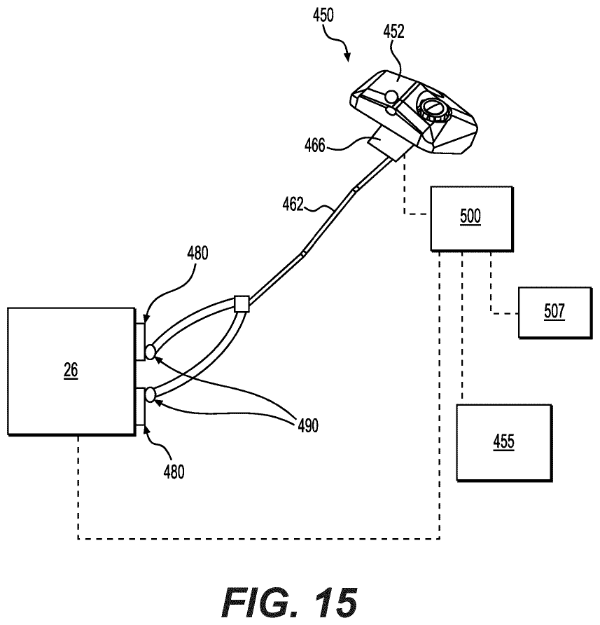

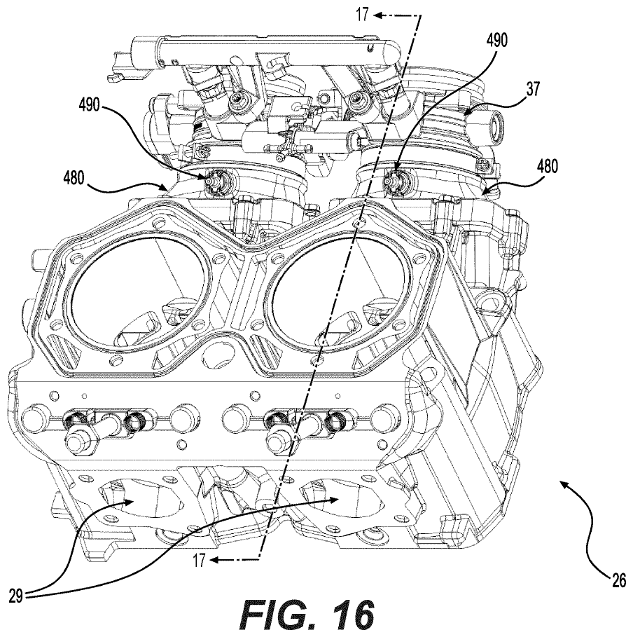

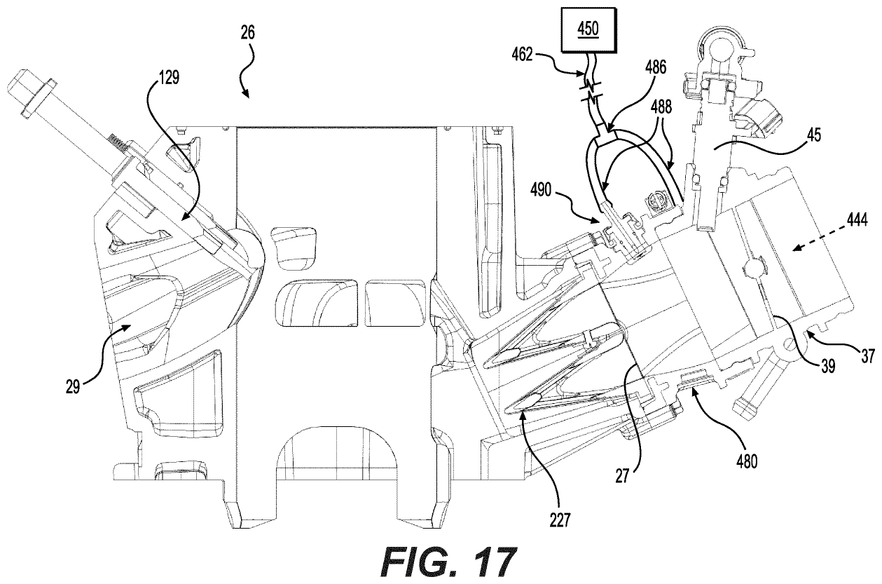

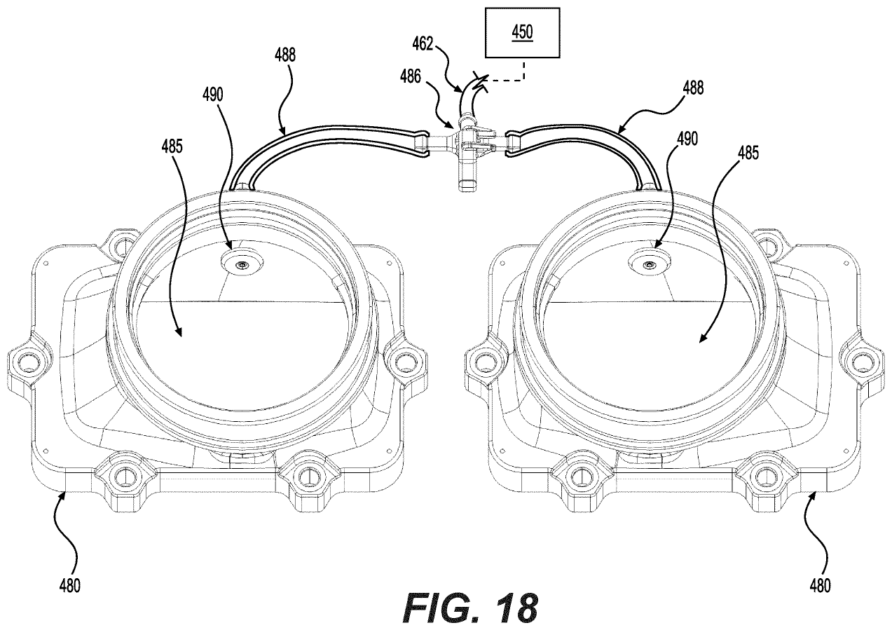

With additional reference to FIGS. 15 to 19, another embodiment of a connection point and arrangement with the coolant container 452 is illustrated. In this non-limiting embodiment, the vehicle 10 includes two coolant-injection collars 480 connected to the engine 26 for injecting coolant into the intake air flow path 444 as described above.

Each coolant-injection collar 480 is connected to the engine 26 between one of the throttle valves 39 of the throttle body 37 and one of the engine air inlets 27, upstream from the corresponding reed valve 227. The intake air flow path 444 passes through an aperture 485 defined by each collar 480. Each collar 480 is formed from rubber, although different materials are contemplated, including for instance resilient plastic. It is also contemplated that the two collars 480 could be integrally formed or connected together.

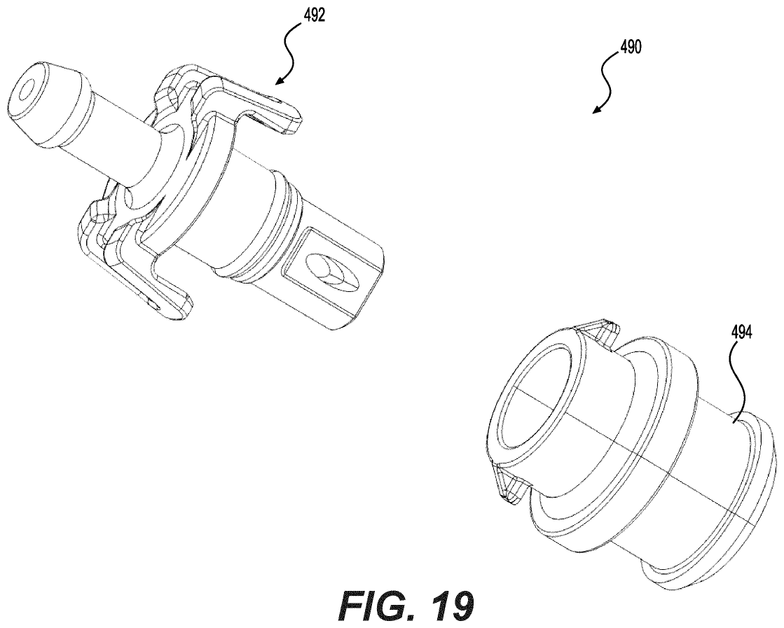

In order to inject coolant, each collar 480 includes a nozzle 490 fluidly communicating with the aperture 485 for selectively supplying coolant to the intake air flow path 444. As is illustrated in FIG. 19, each nozzle 490 is formed from a tube receiving portion 492 and a collar connecting portion 494. The portions 492, 494 snap fit together, although the particular form of the portions 492, 494 could vary. It is also contemplated that the nozzle 490 could be formed from one integrally connected portion.

Each nozzle 490, specifically the tube receiving portion 492, is connected to a tube 488 for providing coolant to the nozzles 490. Both tubes 488 are connected to a T-fitting 486, the T-fitting 486 being connected in turn to the tube 462 connected to the coolant container assembly 450 as described above. In some embodiments, it is contemplated that two pumps could be implemented to provide coolant to each nozzle 490. It is also contemplated that one pump with two outlets could be implemented to provide coolant to each nozzle 490.

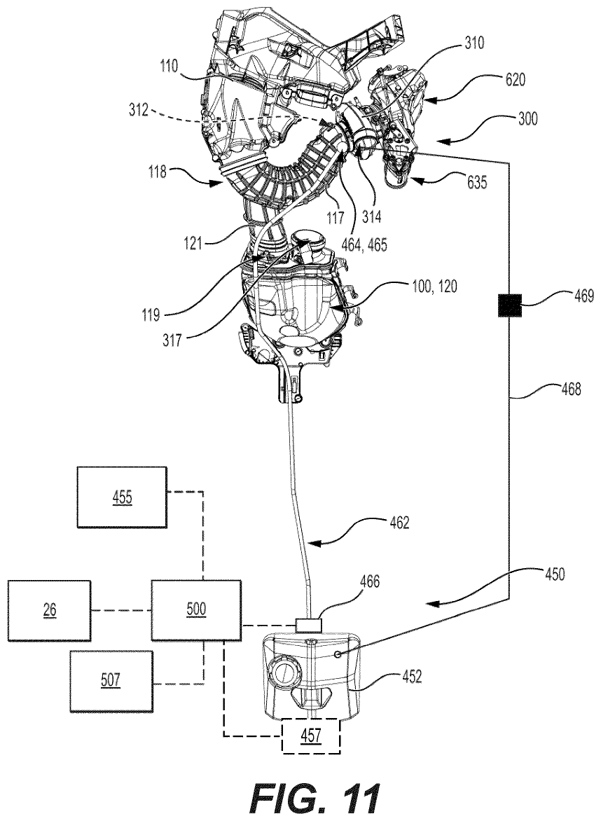

With reference to FIGS. 11 to 13 and 15, the coolant container assembly 450 also includes a solenoid valve 466 disposed and fluidly connected between the coolant container 452 and the coolant tube 462. While the solenoid valve 466 is shown schematically as being connected directly to the coolant container 452, it is contemplated that the valve 466 could be disposed farther from the coolant container 452. For example, additional tubing could connect the valve 466 and the coolant container 452 in some cases, depending on design and space considerations. The solenoid valve 466 selectively controls the flow of the cooling liquid from the coolant container 452 into the tube 462. Controlling the solenoid valve 466 will be described in more detail below. It is contemplated that other types of valves could be used in different implementations. In some implementations, the solenoid valve 466 could be disposed adjacent to or combined with the injection nozzle 465. It is contemplated that the coolant container assembly 450 could include a pump, in addition or in place of the valve 466, fluidly connected to the coolant container 452 for pumping cooling fluid through the coolant tube 462 to the intake air flow path 444.

The snowmobile 10 further includes a pressurization tube 468 for pressurizing the coolant container 452 by fluidly connecting the compressor 310 to the coolant container 452. When the snowmobile 10 is in use, air flows from the compressor 310 to the coolant container 452 via the pressurization tube 468 in order to maintain a certain pressure in the coolant container 452. The pressurization tube 468 includes a pressure regulator 469 in order to prevent over-pressurization, but it is contemplated that other manners for controlling for over-pressurization could be implemented. When the solenoid valve 466 is opened, cooling liquid is forced through the coolant tube 462 by the pressure in the coolant container 452. As such, cooling liquid can be delivered to the intake air flow path 444 from the coolant container 452 without a pump system. As is mentioned above, in some cases the coolant container assembly 450 could include a pump for pumping cooling fluid through the coolant tube 462 to the intake air flow path 444. In such implementations, the pressurization tube 468 could be removed.

The coolant container assembly 450 is communicatively connected with the system controller 500. As is mentioned above, in order to limit the volume and weight added by inclusion of the coolant container, cooling liquid is selectively delivered to the intake air flow path 444. The controller 500 is thus configured to selectively cause an amount of cooling liquid to flow when an estimated piston temperature of a piston of the engine 26 may be hot enough to risk detonation or potentially damage the pistons or other engine components. Specifically, the controller 500 is configured to selectively cause an amount of cooling liquid to flow from the coolant container 452 into the intake air flow path 444 via the connection point 464 based on the temperature of fluids in the intake air flow path 444 and/or based on an estimated piston temperature. Determination of the estimated piston temperature and control of the flow of cooling liquid will be described in more detail below. Specifically, the controller 500 is communicatively connected to the solenoid valve 466 for selectively opening the valve 466 to allow cooling liquid to flow from the coolant container 452.

As is described above, the system controller 500 is also operatively and communicatively connected with the engine control unit (or ECU) and/or the electrical system (not shown) of the snowmobile 10 and receives various engine operation values therefrom. While the same system controller 500 described with respect to the above methods and systems of the snowmobile 10 is used in the present implementation, it is contemplated that a separate and/or additional controller could be utilized and communicatively connected with the system controller 500 and/or the ECU.

Engine operation values received or determined by the controller 500 could include, but are not limited to, previous cooling liquid delivery, ambient air temperature, ambient air pressure, throttle position, the engine speed (RPM), engine load, engine run time, oxygen concentration in the exhaust (lambda), engine coolant temperature, position of the exhaust valves 129, and boost pressure. The boost pressure is sensed by the intake pressure sensor 504 communicatively connected with the controller 500 (described in more detail above). Also mentioned above, the system controller 500 is also operatively and communicatively connected to the atmospheric temperature sensor 505 for sensing the atmospheric or ambient air temperature of the intake air, the exhaust oxygen sensor 513 for sensing the exhaust oxygen concentration, and the ECU for retrieving various operating parameters of the engine 26. The system controller 500 is also communicatively connected with the engine coolant temperature sensor 127. The controller 500 could be connected to various other instruments and/or sensors depending on the particular implementation.

In order to monitor temperature of fluids passing through the air intake flow path 444 (either air or a mixture of air and liquids), the snowmobile 10 includes a temperature sensor 455 configured for determining a temperature of fluid in the intake air flow path 444. In the present implementation, the temperature sensor 455 is disposed on the conduit 316 to determine the temperature of fluid entering the engine 26. A portion of the temperature sensor 455 protrudes into an interior of the conduit 316 for sensing the temperature of the fluid therein. It is contemplated that the temperature sensor 455 could be located elsewhere along the intake air flow path 444, including but not limited to: in or on the secondary airbox 110, the conduit 117, the compressor 310, and the primary airbox 120. In implementations where the temperature is measured upstream from the compressor 310 (e.g. in the airbox 110, the conduit 117, etc.), the temperature being determined would be the air temperature before additional heating from the compressor 310. In some implementations, the temperature sensor 455 could measure ambient temperature of air surrounding the snowmobile 10.

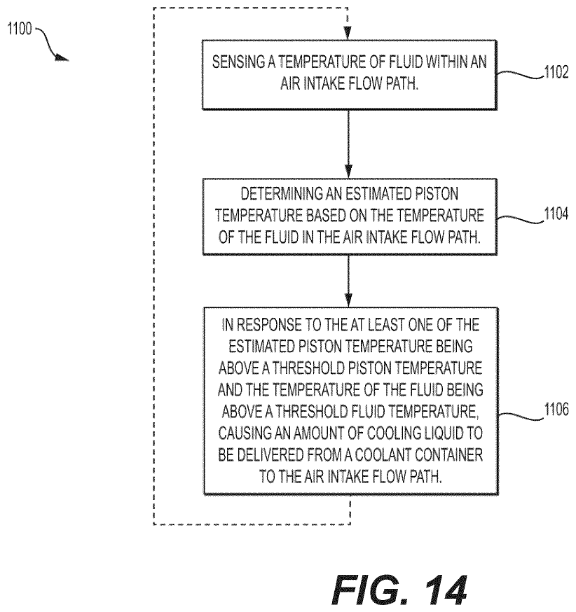

With specific reference to FIG. 14, a method 1100 of managing engine air intake temperature to the turbocharged vehicle 10 using the above described elements of the snowmobile 10 will now be described. Generally, the method 1100 includes sensing intake air temperature and determining by the controller 500 the estimated piston temperature of the engine 26. The estimated piston temperature is retrieved from a piston temperature model by the controller 500, based on the temperature of the intake air and/or engine operation values. In response to one or both the temperature of the fluid (generally intake air) and the estimated piston temperature being above a threshold temperature, the controller 500 then causes some amount of cooling liquid to be delivered to the intake air flow path 444 to aid in reducing the intake air temperature (without necessarily reducing boost from the turbocharger 300 and/or reducing engine speed). The threshold temperatures generally correspond to temperatures above which the engine 26 risks detonation, but the threshold could be differently calibrated.

The method 1100 begins at step 1102 with sensing, by the temperature sensor 455, the temperature of the fluid in the intake air flow path 444, the controller 500 receiving the temperature sensed by the sensor 455. The fluid in the intake air flow path 444 is generally the intake air, but can also include moisture and/or cooling liquid in the intake air flow path 444. As the temperature sensor 455 is downstream from the injection nozzle 465 delivering the cooling liquid, the temperature sensor 455 senses the temperature of both the air and remaining cooling liquid in the conduit 316 when cooling liquid is introduced into the intake air flow path 444. When no cooling liquid is present in the intake air flow path 444 and/or in cases where the temperature sensor 455 is upstream from the injection nozzle 465, sensing the fluid in the intake air flow path 444 generally refers to sensing a temperature of the air in the intake air flow path 444.

The method 1100 continues at step 1104 with determining, by the controller 500, an estimated piston temperature based on at least the temperature of the fluid in the air intake flow path 444 sensed at step 1102. Determining the estimated piston temperature includes retrieving, by the controller 500, the estimated piston temperature from a piston temperature model. In the present implementation, the estimated piston temperature model is stored in and accessible via the storage medium 507 communicatively connected with the system controller 500. It is contemplated that the model could be stored in another computer readable medium communicatively connected to the system controller 500, depending on the implementation. In some implementations, one or more tables or databases of piston temperature based on intake air temperature and/or engine operation values could be provided in place of the model.

In some implementations, the method 1100 further includes determining, by the controller 500, at least one engine operation value. As is mentioned above, engine operation values determined or received by the controller 500 can be selected from one or more of: throttle position, engine speed, engine run time, ambient air temperature, previous cooling liquid delivery, and boost pressure. Depending on the implementation, previous cooling liquid delivery can include the specific quantities of cooling liquid previously delivered to the intake air flow path 444, the number of times cooling liquid has previously been delivered to the intake air flow path 444, and/or time elapsed since the most recent delivery of cooling liquid to the intake air flow path 444. In some implementations, determining the estimated piston temperature at step 1104 is further based on retrieving an estimated piston temperature from the model based on one or more of these determined engine operation values. In implementations where the temperature sensor 455 is upstream of the compressor 310, the estimated piston temperature could be further determined based on an anticipated temperature increase due to compression in the compressor 310.

In some implementations or iterations, the method 1100 could omit step 1102 and begin at step 1104 with determining the estimated piston temperature, where the determination is based on one or more engine operation values.

The method 1100 continues at step 1106 with causing, by the controller 500, in response to at least one of the temperature of the fluid sensed at step 1102 being above a threshold fluid temperature or the estimated piston temperature determined at step 1104 being above a threshold piston temperature, an amount of cooling liquid to flow from the coolant container 452.

The threshold piston temperature and threshold fluid temperature values are pre-determined values stored to the storage medium 507 and correspond to temperatures above which engine efficiency may be affected, including for example due to engine detonation. In some implementations, the threshold temperatures could be dependent on one or more of the engine operation values, such that the controller 500 further determines one or both of the threshold temperatures prior to determining that the estimated piston temperature and/or the temperature of the fluid are greater than the threshold temperatures.

Specifically, causing the amount of cooling liquid to be delivered at step 1106 includes operating, by the controller 500, the solenoid valve 466 of the coolant container assembly 450 to allow the cooling liquid to flow from the coolant container 452. In some implementations, causing the amount of cooling liquid to be delivered includes operating, by the controller 500, a pump of the coolant container assembly 450 to pump the cooling liquid through the coolant tube 462 from the coolant container 452. In some such implementations, the pump could further be configured to provide pressure in the coolant tube 462 to improve delivery of the cooling liquid to the intake air flow path 444.

The amount of coolant (i.e. cooling fluid) delivered to the intake air flow path 444 is determined by the time the solenoid valve 466 is opened by the controller 500. In the present implementation, the estimated piston temperature being above the threshold piston temperature triggers the controller 500 to release a standard amount of cooling liquid, regardless of the difference between the estimated piston temperature and the threshold piston temperature. In some implementations, the controller 500 could determine the amount of coolant to be delivered depending on the temperature sensed by the sensor 455 and/or the estimated piston temperature.

The method 1100 then generally repeats at step 1102 with sensing anew the temperature of fluid in the intake air flow path 444 and/or at step 1104 with determining a revised estimated piston temperature. Depending on the implementation, the method 1100 generally repeats continuously during operation of the snowmobile such that the controller 500 is managing intake air temperature throughout utilization of the snowmobile. In some cases, the method 1100 could repeat at regular time intervals. In other cases, the method 1100 could be triggered by different operational conditions, such as when the engine speed or throttle position indicate that the engine 26 is being operated in conditions likely to increase the piston temperature.

In some cases, the method 1100 could include sensing that the cooling liquid has been emptied from the coolant container 452 and there is no longer any cooling liquid available for delivery to the intake air flow path 444. In some implementations, the method 1100 could further include communicating a message to the operator of the snowmobile 10 that the coolant container 452 is empty. In some cases, the method 1100 could also include reducing engine speed (RPM) or reduce compressor activity from the turbocharger 300 when the fluid temperature and/or the estimated piston temperature are greater than the threshold temperatures and the coolant container 452 is empty.

It is contemplated that the method 1100 could include additional or different steps, either to perform additional functions and/or to perform the steps described above.

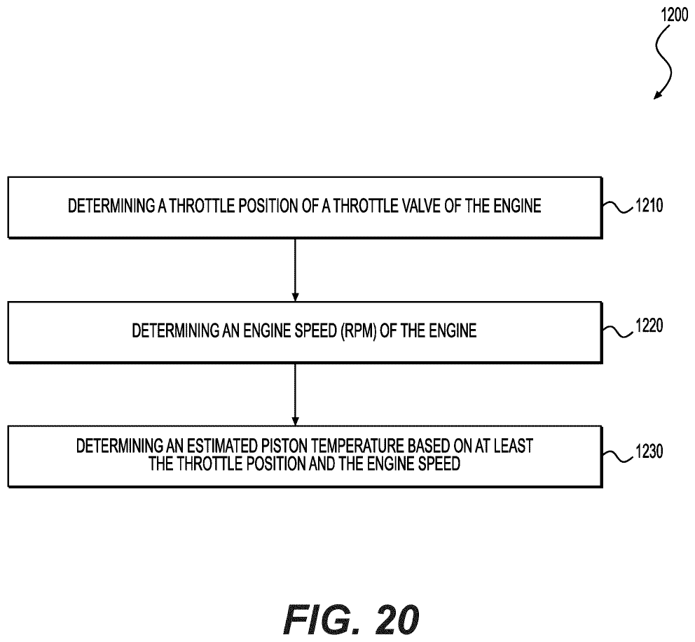

With specific reference to FIG. 20, a method 1200 of managing piston temperature of the engine 26 of the vehicle 10 using the above-described elements of the snowmobile 10 will now be described. Generally, the method 1200 includes determining an estimated steady state piston temperature of the pistons 226 based on the throttle valve position and the engine speed. The estimated piston temperature is retrieved from a piston temperature model by the controller 500, the model being based on the throttle valve position and the engine speed. It is contemplated that the engine load could be used in place of the engine speed in at least some piston temperature model implementations. The estimated piston temperature is then adjusted, where there are changes to engine operation, to determine a non-steady state temperature using a gradient of temperature change caused by those changes in engine operation parameters.

The method 1200 begins, at step 1210, with determining, by the throttle valve position sensor 588, a throttle valve position of the throttle valves 39 of the engine 26. The method 1200 continues, at step 1220, with determining, by the engine speed sensor 586, an engine speed (RPM) of the engine 26. As is noted above, the throttle valve position sensor 588 and the engine speed sensor 586 are communicatively connected to the controller 500, although it is contemplated that a different computer-implemented device could interact with the sensors 588, 586. For example, the ECU could collect information from the sensors 588, 586 in some embodiments.

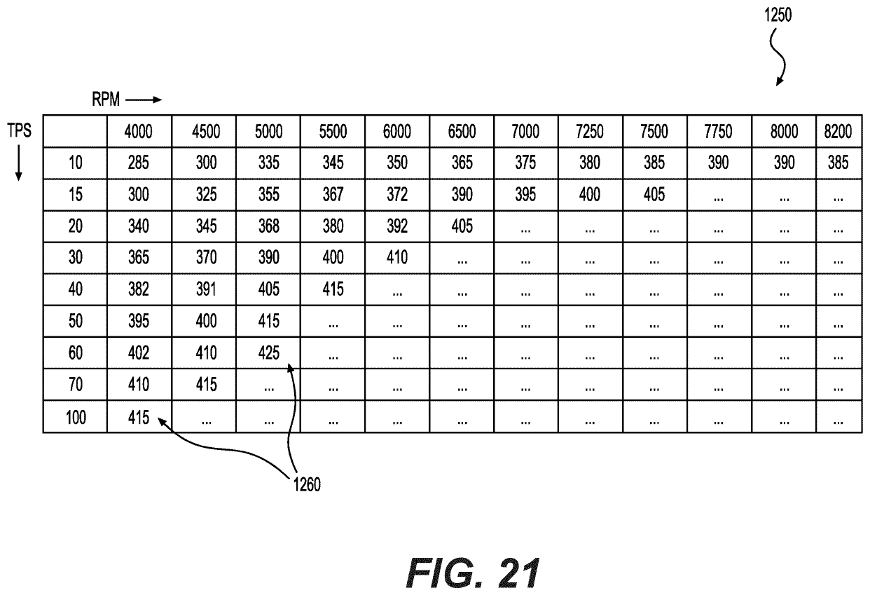

The method 1200 then continues, at step 1230, with determining, by the controller 500, an estimated piston temperature based on at least the throttle position and the engine speed. In at least some embodiments, determining the estimated piston temperature based on the throttle position and the engine speed includes retrieving the estimated piston temperature from a temperature model, also referred to as a temperature dataset. The temperature model, such as the non-limiting example model 1250 illustrated in FIG. 21, provides a steady state temperature (T_{S}) 1260 for the pistons 226 based on engine speed and throttle position. It should be noted that the values illustrated in the model 1250 are not meant to be limiting, and the actual values 1260 of the model 1250 will depend on the particular embodiment of the vehicle 10 and/or the engine 26.

In some cases, the temperature model could be a simulated model of predicted piston temperatures based on operating conditions. It is also contemplated that the temperature model could be constructed from a dataset of measured piston temperatures for different operating conditions. In some cases, the temperature model could be a combination of measured temperatures and extrapolated temperatures based on the measured temperatures.

In some embodiments, the method 1200 could then include determining a temperature gradient (dT/dt) based on a calibration equation stored to (or accessible) to the controller 500. In such embodiments, the temperature gradient is applied when the current (estimated) temperature differs from T_{S}, and more specifically the current temperature is determined to be approaching T_{S} by the temperature gradient. The temperature gradient thus depends on the difference between the current temperature and T_{S}. The calibration equation (not illustrated) is determined based on calibration tests of the engine 26, where the steady state temperature T_{S} is compared to an actual measured piston temperature, measured by a piston temperature sensor. The piston temperature sensor is not included in the vehicle 10, but is instead used in calibration testing of each particular embodiment of the engine 26.

Having determined the temperature gradient adjustment of the steady state piston temperature, a time duration (t) is then applied to the gradient by the controller 500. A revised estimated piston temperature (T) is then determined based on the steady state temperature T_{S}, the temperature gradient dT/dt, and a repeating time elapsed t of the change inducing the temperature gradient. For example, at time=0 the steady state temperature is determined from the engine parameters as described above. Then, for a time duration t=100 ms, as one non-limiting example, the estimated temperature is adjusted using the gradient multiplied by the time duration. In at least some embodiments, the estimated piston temperature (T) is calculated using a temperature determination relation of:

$$T = {T}_{S} + \frac{d T}{d t} t \qquad ( Eq . 1 )$$

In at least some embodiments, the relation could be recursive, where the temperature T is readjusted by the gradient change over another time duration added to the previously determined temperature T.

In some embodiments, the method 1200 could include determining an operational temperature gradient based on a change in one or more engine operation values. Depending on the particular embodiment of the vehicle 10, or the implementation of the method 1200, the engine operation values used to revise the estimated piston temperature could include, but are not limited to, one or more of: an ignition timing of the engine, a fuel pressure, a position of the exhaust valve 129, position of the throttle valve 39, a fuel injection timing, a fuel injection quantity, and a boost pressure from the turbocharger 300. In some cases, changes to piston temperature following injection of coolant into the intake air flow path 444 using the systems described above could be included into adjustments to determined piston temperature. By changing one or more of these engine operation parameters, more or less heat could be generated in the engine 26, thereby changing the temperature of the pistons 226 of the engine 26.

In some cases, the method 200 could include the controller 500 detecting the change in the one or more engine operation values. In such a case, the controller 500 could determine a revised estimated piston temperature based on the estimated piston temperature previously determined, as well as the detected change in engine operation value. In some cases, determining the revised estimated piston temperature is further based on a time duration of the change in the one or more engine operation values.

In some embodiments, the method 1200 could further include determining an engine coolant temperature, by the engine coolant temperature sensor 127, and an intake air temperature, by the atmospheric air temperature sensor 505. In some such cases, the method 1200 could then include determining, by the controller 500, a revised piston temperature based on at least the steady state piston temperature or the revised estimated piston temperature T, the engine coolant temperature, and the intake air temperature. In some embodiments, adjustments to the determined piston temperature to determine the revised piston temperature could be based on just one of the engine coolant temperature or the intake air temperature.

In some non-limiting embodiments, the method 1200 could also include determining, by the controller 500, a difference between a desired piston temperature and the estimated piston temperature. In such cases, the method 1200 could then include causing a modification, by the controller 500, to one or more engine operation values of the engine 26. In some embodiments, a magnitude of the modification to the one or more engine operation values could be based at least in part on the difference between the desired piston temperature and the estimated piston temperature.

For example, if the estimated piston temperature, determined using the model 1250 of steady state temperature T_{S}, is higher than a predetermined threshold operating temperature, the controller 500 could cause a decrease in engine speed in order to aid in decreasing heat created in the engine 26, thereby aiding in decreasing piston temperature. In some embodiments, the method 1200 could include determining a temperature gradient caused by modifying the one or more engine operation values and then determining, based at least on the temperature gradient and the difference between the desired piston temperature and the estimated piston temperature, a time of modification for one or more engine operation value. The controller 500 could then control the engine 26 to modify the one or more engine operation values for the determined time of modification.

In some non-limiting embodiments, the method 1200 further includes, in response to the estimated piston temperature being above a threshold temperature, the controller 500 to cause some amount of cooling liquid to be delivered to the intake air flow path 444 to aid in reducing the intake air temperature (without necessarily reducing boost from the turbocharger 300 and/or changing engine operation values). Reducing the intake air temperature could, in at least some instances, aid in reducing the piston temperature. The threshold temperatures generally correspond to temperatures above which the engine 26 risks detonation, but the threshold could be differently calibrated. In some non-limiting embodiments, the method 1200 could further include, in response to the estimated piston temperature being above a threshold temperature, the controller 500 to cause changes to one or more engine operation parameters.

It is contemplated that the method 1200 could include additional or different steps, either to perform additional functions and/or to perform the steps described above.

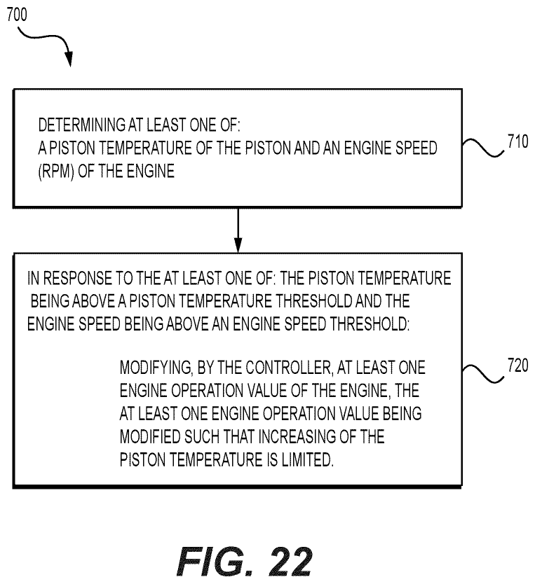

With reference to FIG. 22, a method 700 for managing piston temperature of the engine 26 of the snowmobile 10 will now be described. Broadly, the method 700 can be implemented to limit heating of the pistons 226 by adjusting engine operation properties in order to avoid knocking (detonation) as well as heat-related piston or engine damage over the long term.

The method 700 begins, at step 710, with determining at least one of a piston temperature of one or both of the pistons 226 and an engine speed (RPM) of the engine 26. Depending on the embodiment, the method 700 could include determining both the piston temperature and the engine speed. In some cases, the method 700 could rely on only one of the piston temperature and the engine speed. It is also contemplated that the method 700 could rely additionally or alternatively on the engine load.

In the present implementation, the engine speed is determined by receiving engine speed data, at the controller 500, from the engine speed sensor 586. The engine speed could be differently determined or calculated depending on the particular embodiment. In the present embodiment, determining the piston temperature includes determining an estimated piston temperature based on engine operational parameters. Specifically, the method 700 could include using the method 1200 described above to determine the estimated piston temperature, although other methods are contemplated.

The method 700 continues, at step 720, with modifying at least one engine operation value of the engine 26, in response to the piston temperature being above a piston temperature threshold and/or the engine speed being above an engine speed threshold. The engine operation value(s) are modified such that increasing of the piston temperature is limited. According to the present technology, changes to each engine operation value are selected based on a corresponding effect on change in piston temperature.

Depending on the particular embodiment, exact values of operational value change can be determined on a value map of change in operational value versus estimated change in temperature of the pistons 226. The value map could be saved to or accessible by the controller 500. In some cases, the controller 500 could be programmed with equations relating operational values to changes in piston temperature. In the present embodiment, the one or more engine operation values to be adjusted by the method 700 could be selected from: ignition timing of the engine 26; air-to-fuel ratio; exhaust valve position; fuel injection timing; fuel injection quantity; and boost pressure from the turbocharger 300. In other embodiments, additional or alternative engine operational values could be used to manage the piston temperature.

In at least some embodiments, the piston temperature threshold could be a first piston temperature threshold for managing piston temperature, the first piston temperature threshold being chosen for adjusting the one or more engine operation values to control piston temperature. In such cases, the method 700 could further include causing coolant fluid to flow from the coolant container 452 to the air intake flow path 444 fluidly connected to the pistons 226, in response to the piston temperature being above a second piston temperature threshold. In the present embodiment, the first piston temperature threshold is greater than the second piston temperature threshold. As such, use of coolant fluid assists in limiting temperature increases of the pistons 226 before control of engine operation values are activated. In at least some embodiments, the method 700 could further include causing coolant fluid to flow from the coolant container 452 to the air intake flow path 444 fluidly connected to the pistons 226, in response to the engine speed being above the engine speed threshold. In some embodiments, the amount of coolant flowing to the air intake flow path 444 is based at least in part on the piston temperature and/or the engine speed.

In at least some embodiments, the method 700 could further include determining that a fluid level of coolant fluid in the coolant container 452 is below a minimum fluid level. For example, determination of the fluid level could be made from information received from the coolant level sensor 457. It is also contemplated that the fluid level could be determined from pressure in the coolant tube 462. In at least some such cases, the method 700 could cause fluid to stop flowing from the coolant container 452 to the air intake flow path 444 in response to determining that the fluid level is below the minimum fluid level.

In at least some embodiments, the method 700 could further include determining that the coolant container 452 is empty. Subsequent to determining that the coolant container 452 is empty, the method 700 could include modifying one or more engine operation values in response to the piston temperature being above a third piston temperature threshold, where the third piston temperature threshold is less than the first piston temperature threshold. As such, when the coolant container 452 is empty, the controller 500 controls the engine operation values to limit piston temperature increases at a lower temperature, relative to combined use of the coolant and engine operation value control.

In at least some embodiments, determining an amount of coolant fluid to cause to flow is based at least in part on one or more of the piston temperature; ambient temperature; primary plenum temperature; time spent above a predetermined engine load; and time spent above a predetermined engine speed. In some such embodiments, determining the amount of coolant fluid to cause to flow is further based at least in part on the engine speed and/or the engine load.

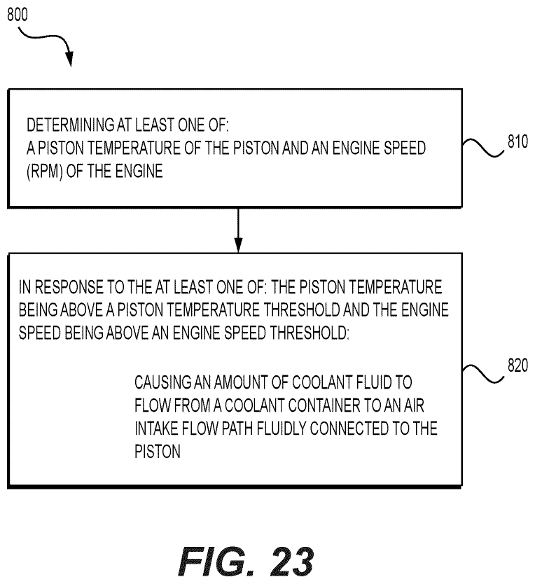

With additional reference to FIG. 23, another non-limiting embodiment of a method 800 for managing piston temperature of the engine 26 of the snowmobile 10 using the above-described elements of the snowmobile 10 will now be described.

The method 800 begins, at step 810, with determining at least one of a piston temperature of one or more of the pistons 226, an engine load, and an engine speed (RPM) of the engine 26. Depending on the embodiment, the method 800 could include determining both the piston temperature and the engine speed. In some cases, the method 800 could rely on only one of the piston temperature, the engine load, and the engine speed.

In the present implementation, the engine speed is determined by receiving engine speed data, at the controller 500, from the engine speed sensor 586. The engine speed could be differently determined or calculated depending on the particular embodiment. In the present embodiment, determining the piston temperature includes determining an estimated piston temperature based on engine operational parameters. Specifically, the method 800 could include using the method 1200 described above to determine the estimated piston temperature, although other methods are contemplated. For example, according to some embodiments, the method 800 could further include determining a throttle position and determining the engine speed using the engine speed sensor 586.

The method 800 continues, at step 820, with causing an amount of coolant fluid to flow from the coolant container 452 to the air intake flow path 444 fluidly connected to the pistons 226, in response to the piston temperature being above a piston temperature threshold and/or the engine speed being above an engine speed threshold. It is noted that the piston temperature threshold and/or the engine speed threshold could have same or different values for the methods 700, 800, or could depend on the particular embodiment.

In at least some embodiments, determining an amount of coolant fluid to cause to flow is based at least in part on one or more of the piston temperature; ambient temperature; primary plenum temperature; time spent above a predetermined engine load; and time spent above a predetermined engine speed. In some such embodiments, determining the amount of coolant fluid to cause to flow is further based at least in part on the engine speed and/or the engine load.

In at least some embodiments, the method 800 could further include determining that a fluid level of coolant fluid in the coolant container 452 is below a minimum fluid level. For example, determination of the fluid level could be made from information received from the coolant level sensor 457. It is also contemplated that the fluid level could be determined from pressure in the coolant tube 462. In at least some such cases, the method 800 could cause fluid to stop flowing from the coolant container 452 to the air intake flow path 444 in response to determining that the fluid level is below the minimum fluid level.

In at least some embodiments, the method 800 could further include determining that the coolant container 452 is empty. Subsequent to determining that the coolant container 452 is empty, the method 800 could include modifying one or more engine operation values in response to the piston temperature being above a second piston temperature threshold. As such, when the coolant container 452 is empty, the controller 500 controls the engine operation values to limit piston temperature increases using engine operation value control when coolant is no longer available.

It is contemplated that the methods 700, 800 could include additional or different steps, either to perform additional functions and/or to perform the steps described above.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method for managing temperature of a piston of an engine of a vehicle, the method being executed by a controller of the vehicle, the method comprising:
determining a piston temperature of the piston;
determining at least one of:
an engine load of the engine, and
an engine speed (RPM) of the engine;
in response to:
the piston temperature being above a first piston temperature threshold; and
at least one of:
the engine load being above an engine load threshold, and
the engine speed being above an engine speed threshold,
modifying, by the controller, at least one engine operation value of the engine, the at least one engine operation value being modified such that increasing of the piston temperature is limited; and
in response to the piston temperature being above a second piston temperature threshold, causing coolant fluid to flow from a coolant container to an air intake flow path fluidly connected to the piston, the first piston temperature threshold being greater than the second piston temperature threshold.

2. The method of claim 1, wherein the at least one engine operation value is at least one of:
an ignition timing of the engine;
an air-to-fuel ratio;
an exhaust valve position;
a fuel injection timing;
a fuel injection quantity; and
a boost pressure from a turbocharger of the vehicle.

3. The method of claim 1, wherein an amount of coolant flowing to the air intake flow path is based at least in part on at least one of the piston temperature and the engine speed.

4. The method of claim 1, further comprising:
determining that a fluid level of coolant fluid in the coolant container is below a minimum fluid level; and
in response to determining that the fluid level is below the minimum fluid level, causing fluid to stop flowing from the coolant container to the air intake flow path.

5. The method of claim 1, further comprising:
determining that the coolant container is empty; and
subsequent to determining that the coolant container is empty, in response to the piston temperature being above a third piston temperature threshold, modifying the at least one engine operation value,
the third piston temperature threshold being less than the first piston temperature threshold.

6. The method of claim 1, wherein causing coolant fluid to flow comprises:
determining an amount of coolant fluid to cause to flow based at least in part on at least one of:
the piston temperature;
ambient temperature;
primary plenum temperature;
time spent above a predetermined engine load; and
time spent above a predetermined engine speed.

7. The method of claim 6, wherein determining the amount of coolant fluid to cause to flow is further based at least in part on at least one of:
the engine speed; and
the engine load.

8. The method of claim 1, wherein determining the at least one of the piston temperature, the engine load, and the engine speed comprises:
determining the piston temperature, and
determining at least one of the engine speed and the engine load.

9. The method of claim 1, wherein determining the piston temperature comprises determining an estimated piston temperature based on a plurality of engine operational parameters.

10. A method for managing temperature of a piston of an engine of a vehicle, the method being executed by a controller of the vehicle, the method comprising:
determining at least one of:
a piston temperature of the piston,
an engine load of the engine, and
an engine speed of the engine; and
in response to the at least one of:
the piston temperature being above a piston temperature threshold,
the engine load being above an engine load threshold, and
the engine speed being above an engine speed threshold,
causing an amount of coolant fluid to flow from a coolant container to an air intake flow path fluidly connected to the piston, causing the amount of coolant fluid to flow comprises determining the amount of coolant fluid based at least in part on at least one of:
a primary plenum temperature;
a time spent above a predetermined engine load; and
a time spent above a predetermined engine speed.
